(19) United States
(12) Patent Application Publication
(10) Pub. No.: US 2007/0129112 A1
(43) Pub. Date: Jun. 7, 2007

(54) Methods of Implementing an Operation Interface for Instant Messages on a Portable Communication Device

(76) Inventor: Liang-Chern Tarn, Sanchueng (TW)

Correspondence Address: WILSON SONSINI GOODRICH & ROSATI, 650 PAGE MILL ROAD, PALO ALTO, CA, 94304-1050, US

(21) Appl. No.: 11/538,026

(22) Filed: Oct. 2, 2006

Related U.S. Application Data
(63) Continuation-in-part of application No. 11/275,019, filed on Dec. 1, 2005.

(51) Int. Cl. H04B 1/38

(52) U.S. Cl. 455/566; 455/466

(57) ABSTRACT

An operation interface for instant messages (IM) on a portable communication device is provided. In method of implementing such interfaces, the contacts or IM systems are organized and sorted. In addition, a counter can be set to record of the number of times an incoming message is received or an outgoing message is sent for each contact and/or to record the number of messages that are read or unread for each contact. The sequence order of contacts can be rearranged according to a predefined sort preference for display on the screen of the device. The user may specify the sort preference to be by display name, date last contacted, most frequent contacts, relationship, company, etc. The user may also specify the sort preference to display names in order alphabetically, by stroke number or when expressed in Chinese characters, or in Pinyin order when expressed in Pinyin.

This is a continuation-in-part patent application of U.S. patent application Ser. No. 11/275,019 filed Dec. 1, 2005 which is incorporated by reference herein in its entirety.

### BACKGROUND OF THE INVENTION

1. Field of the Invention

The present invention relates to methods of implementing an operation interface for instant messages, particularly to user interfaces for instant messages on portable communication devices, whereby users can identify contacts to incoming messages, search and access desired contacts, and/or automatically correct outgoing messages.

2. Description of the Related Art

Currently, some of the most popular instant message (IM) systems, such as MSN (Messenger, Microsoft Corporation) and Yahoo! Messenger (Yahoo! Inc.), support the ability of users to organize contacts into groups. FIG. 1 shows a conventional contact arrangement of an IM system on a computer or personal digital assistant (PDA). A user himself/herself can create any number of groups and name them for display on a computer or PDA screen 10, such as Family, Relatives, Friends, Colleagues, Neighbors, etc. The type of conventional IM interface generally exhibits groups and contacts in a hierarchical tree structure. A number of contacts are displayed on the screen within designated groups. In this way, it may be satisfactory for computer users to search a desired contact on the display screen by scrolling or navigating around the interface by pressing directional keys or tapping a scrolling bar 12.

These conventional IM systems generally arrange all contacts in alphabetic order and ASCII (American Standard Code for Information Interchange) order. However, this format is often meaningless for users because the contacts are recognized by some other designation and usually have associated nicknames that are displayed on the screen. Further, the most frequent contacts do not necessarily appear on the top of the displayed contact list. Therefore, the user often has difficultly in finding a desired contact rapidly.

Many other disadvantages exist in the conventional IM system interfaces. For example, IM client software for portable devices presently display contacts in a relatively disorganized manner. All contacts are provided in a single list displayed on the screen of portable device usually in some type of outline format with some indentation. Further, with respect to a general portable devices such as a handset device or cellular telephone, the user can only operate the interface by using key buttons, and it is very unfriendly and difficult for the user to search and target a desired contact entry. Moreover, a conventional IM system will also prompt the user with an audible sound and/or a small message window may pop-up when a message is incoming. But it is often difficult for a portable device to effectively show even smaller message windows on the limited screen of a portable device.

In current available IM systems, a user also can not easily create/edit a message before sending it out. While typing a message with a full size computer keyboard is relatively very easy, it is relatively excruciating and painful for a user to type messages on a portable device. The users can either type a message character-by-character by using key buttons of limited in size, by touch panel taping or other inconvenient ways adapted for text entry in portable devices. Furthermore, the user of a portable device often types wrong or misspelled words by following current input method with limited key buttons. There is a need for an improved IM interface that is organized and better designed for actual patterns of use for each individual.

### SUMMARY OF THE INVENTION

For solving the aforementioned problems, the present invention provides methods and devices for presenting and implementing operation interfaces for instant messages on portable communication devices. Various aspects of the invention herein can be appreciated individually or collectively to provide an effective user interface for managing and displaying instant messages on portable devices.

The present invention provides methods of implementing an operation interface for instant messages on a portable communication device, wherein the contacts are organized into multiple groups such as an active group or a non-active group.

Another embodiment of the invention provides a method of implementing an operation interface for instant messages on a portable communication device, wherein the user can change the groups by using a navigator key or predefined hotkeys, and the user can change the IM systems by predefined hotkeys.

Yet another embodiment of the invention is to provide a method of implementing an operation interface for instant messages on a portable communication device, wherein a counter is configured to track or count the number of times incoming messages are received for each contact, and to generate a sequence order for the contacts to be displayed by sorting the incoming messages received from each contact based on the record(ed) values of the counter. A sorting period can be defined in advance by a user to present messages in a defined order at selected time intervals. In a preferable alternate embodiment of the invention, contacts with greater or higher counter values, which represent the number of incoming messages for each, will be displayed on the top portion of a contact list within the operation interface or display screen of a portable communication device.

Another embodiment of the invention provides operation interfaces for instant messages on a portable communication device with audible or visual notification signals. For example, when a user receives an incoming message, the user may be prompted by a sound or audible signal such as a beep or a series of one or more tones. In addition, if the incoming message is sent by a contact within a designated (active) group, the user may be further prompted by flashing signal or icon within the screen of the device corresponding to the contact and/or the (active) group. In yet another embodiment of the invention, when an incoming message is sent by a (non-active) group member, the user may be prompted by flashing the icon corresponding to the (non-active) group or contact therein. These and other signals may be assigned for any designated contacts within active, non-active or other defined groups.

Still another embodiment of the invention provides methods of implementing an operation interface for instant messages on portable communication devices with spell checking capabilities. For example, when the IM system detects an outgoing message or one that is being edited, a spellcheck program resident in the memory of the device can be automatically activated as the message is created or when completed. Moreover, the invention also provides methods of implementing an operation interface for instant messages, wherein a user can scroll to a marquee on the operation interface in the display screen to show the nickname of a contact in the active group or other defined groups.

Another embodiment of the present invention provides a method of implementing an operation interface for instant message (IM) systems on a portable communication device. The method creates a plurality of contacts for display within the operation interface on the portable communication device display screen, provides an IM event counter for display corresponding to each contact, sorts the plurality of contacts according to a predefined sort preference, and displays the plurality of contacts within the operation interface on the portable communication device display screen according to the predefined sort preference.

Another embodiment of the invention sets the IM event counter such that the counter records the number of times incoming messages are received or outgoing messages are sent corresponding to each contact. Still another embodiment of the invention sets the IM event counter such that the counter records the number of messages read or messages unread corresponding to each contact.

In another embodiment of the invention, each contact is associated with a display name. In a preferable embodiment of the invention, the predefined sort preference orders the contacts by display names in alphabetical order.

In another embodiment of the invention, each contact is associated with a display name expressed in Chinese characters or Hanzi formed of a selected number of strokes and radicals. The predefined sort preference may order the contacts by the total number of strokes of each of the display names. Alternatively, the predefined sort preference may order the contacts first by the number of strokes of the radical of each Chinese character or Hanzi and then by the number of strokes of the non-radical of each Chinese character or Hanzi.

In another embodiment of the invention, each contact is associated with a display name expressed in Pinyin and the predefined sort preference orders the contacts by display names in Pinyin order.

In another embodiment of the invention, a time-last-contacted tracker is kept for each contact to record the date and time an incoming or outgoing message was last received or sent to that contact. The predefined sort preference order may order the contacts by the values of the time-last-contacted tracker.

In another embodiment of the invention, the predefined sort preference orders the contacts by the IM event counter values. In another embodiment of the invention, the predefined sort preference further orders the contacts by the IM event counter values in ascending order. Alternatively, the predefined sort preference may order the contacts by the IM event counter values in descending order.

In another embodiment of the invention, each contact is associated with a relationship type and the predefined sort preference orders the contacts by the relationship type.

In another embodiment of the invention, each contact is associated with a company name, and the predefined sort preference orders the contacts by the company name.

The present invention also provides an instant message (IM) system user interface. The IM system user interface has a listing of a plurality of contacts ordered in a predefined sort preference; a link to a plurality of sort preference options so that upon selection of a desired sort option, the plurality of contacts can be ordered according to the selected sort preference, and a graphical representation of the values of an IM event counter corresponding to each contact.

The present invention also provides a computer readable medium having program code recorded thereon for presenting an instant message (IM) system user interface. The program code causes a machine to perform steps of creating a plurality of contacts for display within the operation interface on the portable communication device display screen, providing an IM event counter for display corresponding to each contact, sorting the plurality of contacts according to a predefined sort preference, and displaying the plurality of contacts within the operation interface on the portable communication device display screen according to the predefined sort preference.

The graphical user interfaces and methods of implementing interfaces for instant messages on portable communication devices provided in accordance with the invention offer these and many other benefits which allow a user to easily identify contacts for incoming messages, rapidly searching and accessing desired contacts, and automatically correct an outgoing message. Other goals and advantages of the invention will be further appreciated and understood when considering the specification and drawings herein.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

To enable the objectives, the characteristics and the functions of the present invention to be further understood, the preferred embodiments of the present invention is to be described in detail below in cooperation with the attached drawing, and wherein:

FIG. 1 shows a conventional contact arrangement of IM system on a computer or PDA;

FIG. 2 shows a flowchart of a method of implementing an operation interface for instant messages on a portable communication device according to a first embodiment of the invention;

FIGS. 3A and 3B show an operation interface for instant messages on a portable communication device related to the first embodiment of the invention shown in FIG. 2;

FIG. 4 shows a flowchart of a method of implementing a user interface for instant messages on a portable communication device related to a second embodiment of the invention; and

FIGS. 5A and 5B show a user interface for instant messages on a portable communication device related to the second embodiment of the invention shown in FIG. 4.

FIG. 6 shows a flowchart of a method of implementing an operation interface for instant messages on a portable communication device according to one embodiment of the invention;

FIGS. 7A, 7B and 7C show a user interface for sorting a contact list for instant messages on a portable communication device according to one embodiment of the invention;

FIG. 8A shows a contact list for instant messages on a portable communication device sorted alphabetically by display name.

FIG. 8B shows a contact list for instant messages on a portable communication device, where the display names are expressed in Chinese characters or Hanzi, sorted by the total number of strokes of each of the display names.

FIG. 8C shows a contact list for instant messages on a portable communication device, where the display names are expressed in Chinese characters or Hanzi, sorted first by the number of strokes of the radical of each Chinese character or Hanzi and then by the number of strokes of the non-radical of each Chinese character of Hanzi.

FIG. 8D shows a contact list for instant messages on a portable communication device, where the display names are expressed in Pinyin, sorted in Pinyin order.

FIG. 8E shows a contact list for instant messages on a portable communication device, sorted by the date each contact was last contacted.

FIG. 8F shows a contact list for instant messages on a portable communication device, sorted by the frequency of communications with each contact.

FIG. 8G shows a contact list for instant messages on a portable communication device, sorted by the relationship type of each contact.

FIG. 8H shows a contact list for instant messages on a portable communication device, sorted by the company of each contact.

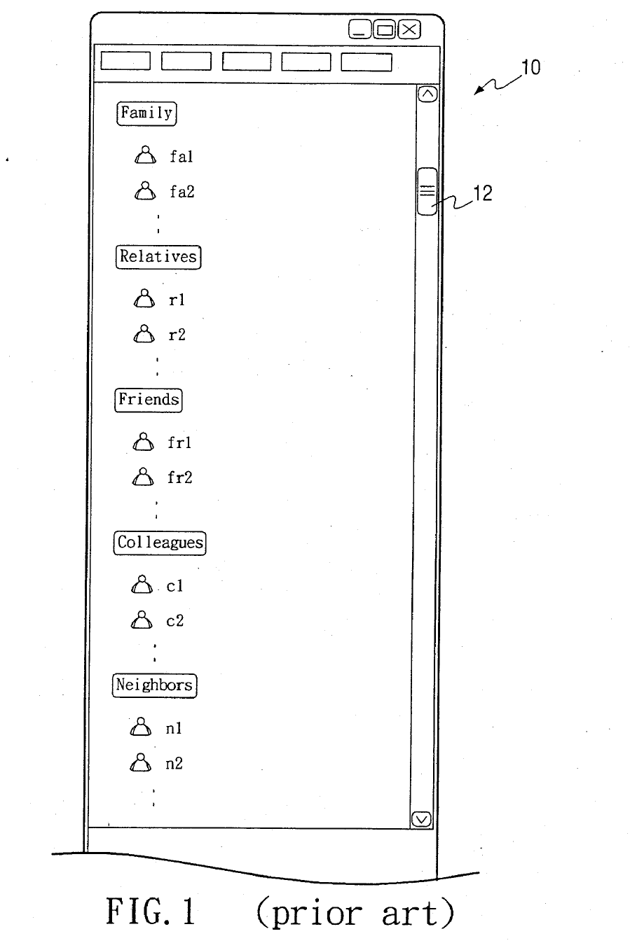

### DETAILED DESCRIPTION OF THE INVENTION

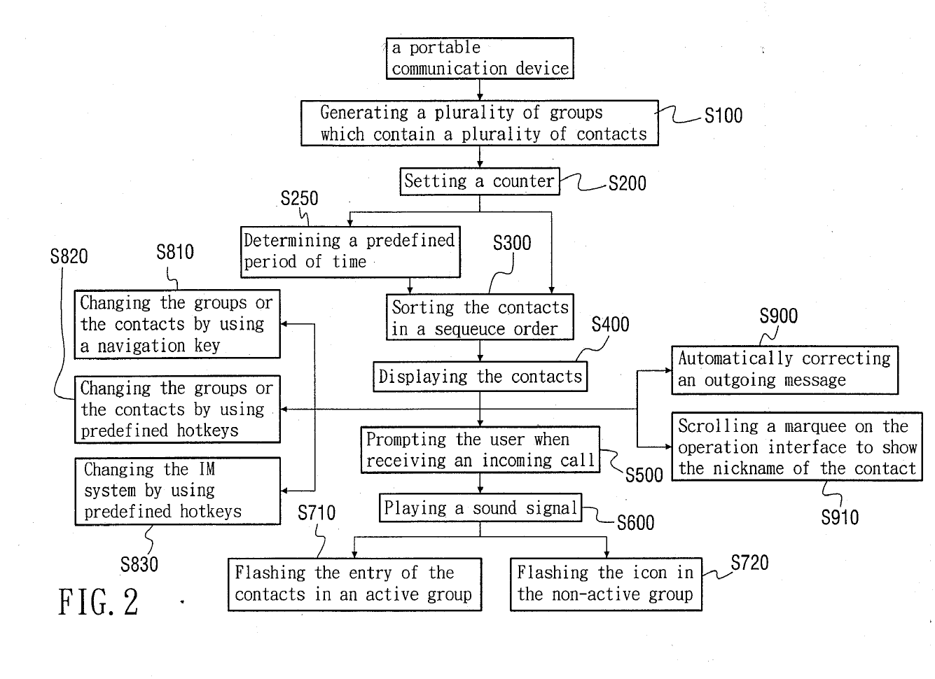

FIG. 2 shows a flowchart illustrating a method of implementing an operation interface for instant messages on a portable communication device according to a first embodiment of the present invention.

In the first embodiment, the portable communication device used in the invention includes a display screen, a navigation key, and several key buttons. This method may also include one or more of the following steps: a user generates several groups in the portable communication device, such as an active group and a non-active group, and wherein each group contains several contacts shown on the operation interface in the display screen (S100); a counter for each of the contacts that can be set to accumulate and count the number of times (1, 2, 3, 4 . . . ) of incoming messages received and/or outgoing messages sent by a user for each corresponding contact (S200); sorting the contacts in a sequence order according to the counter (counted) values can be also performed (S300); the contacts on the operation interface in the display screen can also be shown according to the sorted contacts (S400). Before performing the step of sorting the contacts in a sequence order according to the counted values is preferably performed, the user can set a predefined period of time for sorting (S250). For example, the step of sorting the contacts can be initialized each day (eg, every 24 hours or other time interval) and respective counters can be reset to “0” value(s). The contacts with whom a user corresponds the most within each given time interval can be prioritized and appear in more prominent and visible portions of the user interface including the top of the screen or interface for a portable communication device.

In addition, once the user receives an incoming message, the portable communication device can prompt or notify the user (S500). This prompting may be a sound signal played by the portable communication device (S600). Further, the portable communication device can flash the entry (such as MSN or Yahoo entry) if the incoming message comes from a particular contact within an active group (S710), and/or flash the icon of a contact if the incoming message originates or comes from a member or contact of a non-active group (S720). Moreover, when the user needs to navigate to or find another group or contact within the user interface, the user may utilize a series of one or more navigation keys or predefined hotkeys on the portable communication device (S810 and S820). In some embodiments of the invention, the predefined hotkeys may be some of the button keys. Also, when the user wants to switch over to or change respective IM systems, these predefined hotkeys may be utilized by the user (S830) to change between the IM systems such as switching from a MSN to a Yahoo chat session.

In a preferable embodiment of the invention, a user interface may include a spellcheck button or option so the IM system can also automatically correct spelling and/or grammatical errors in an outgoing or draft message being prepared when the portable communication device detects that an outgoing message is being sent or edited (S900). Another embodiment of the invention provides added convenience allowing user to scroll to a marquee or icon on the operation interface to see or display the nickname of a relevant contact (S910).

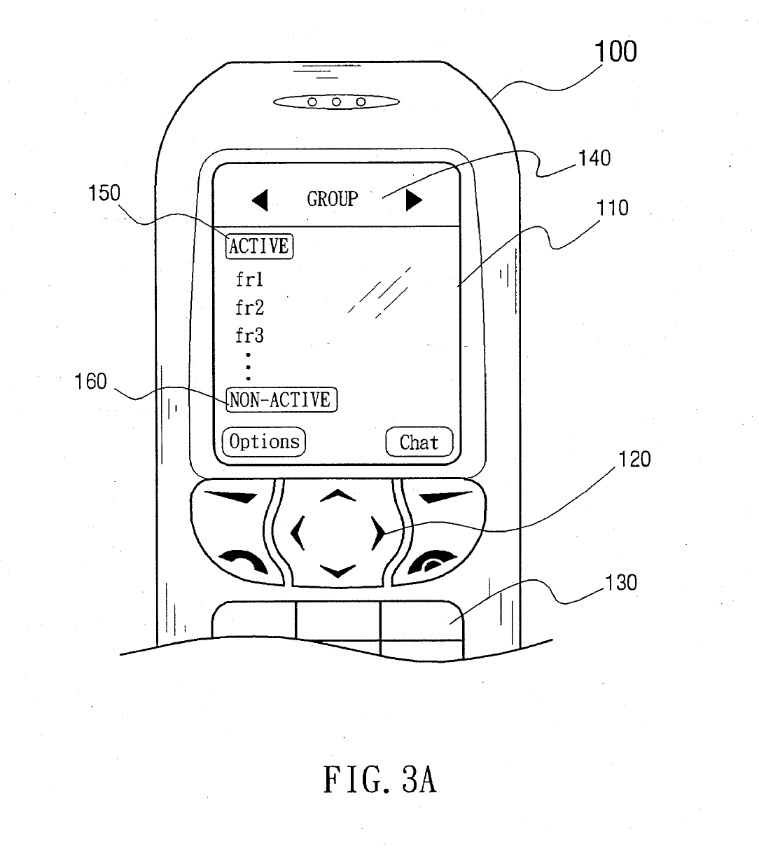

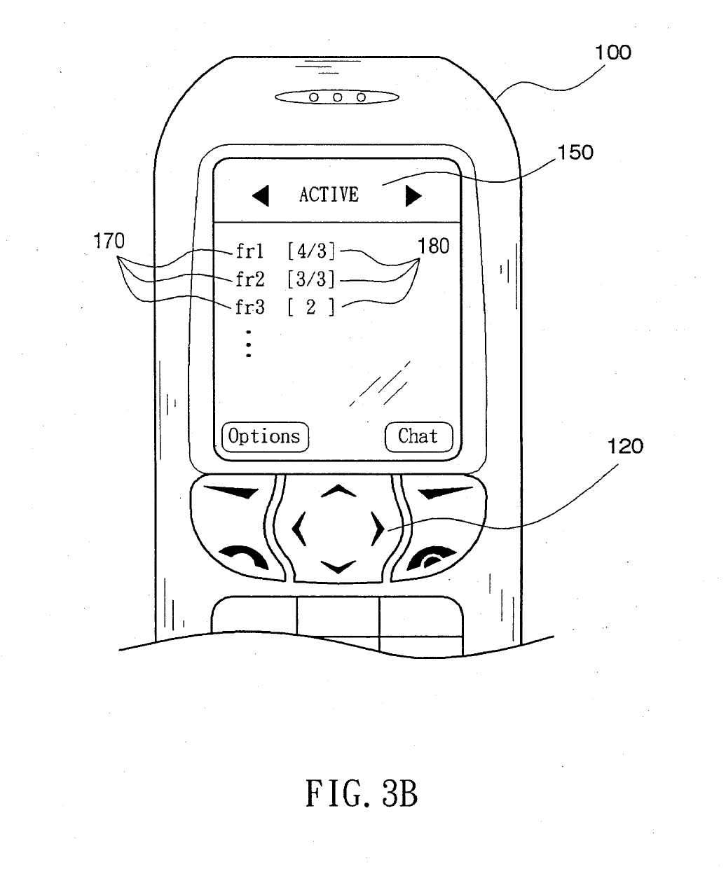

FIGS. 3A and 3B show the user (operation) interface for instant messages on a portable communication device implemented by a method similar to that described in FIG. 2. The portable communication device 100 includes a display screen 110, navigation key 120, and several button keys 130.

In this embodiment of the invention, the interface on the display screen 110 includes a group 140 containing an active group 150 and a non-active group 160. Each of these or any other defined group provided herein may be identified with a corresponding icon or other graphical illustration on the display screen 110. The active group 150 may be defined to include all contacts designated to be in chatting status, whereby the user can easily switch to a different chat sessions within the active group 150 by choosing an entry shown in the operation interface, and wherein the active group 150 may further include multiple types of IM systems in the active group 150 that are designated as subgroups. On the other hand, the non-active group 160 may be defined to include contacts which are not designated on the displayed list to be in chatting status, wherein the non-active group 160 may also include various contacts from multiple types or different IM systems as subgroups illustrated within the interface. In an alternate embodiment of the invention, as shown in FIG. 3A, the user interface may include a limited or user configured hierarchical display of contacts within an active (or non-active group) together with icons to other non-active groups in the interface but without displaying their contents or relevant contacts therein which are not active and not immediately purposeful to the user. FIG. 3B also illustrates a series of one or more counters [x/y] for each of the contacts 170 (fr1, fr2, fr3 . . . ) that can be set to accumulate and count the number of times of incoming messages (x) received and/or outgoing messages (y) sent by a user for each corresponding contact. The contacts can be sorted and displayed in a sequence order according to the counter (higher to lower “x”) values. This sequence order may be refreshed and reset by a user when desired at regularly scheduled intervals or defined time periods (eg, daily, weekly, etc) as desired. The sequence order for the displayed contacts may also be selected in a manner other than the counted values by a user.

In these kinds of an arrangements described above, the contacts stored within a portable device can be user organized in a practical and effective manner. All contacts are therefore not displayed unnecessarily in one list on the screen, and the user of the portable communication device 100 can also more easily search the contact through conveniently organized active, non-active or any other groups.

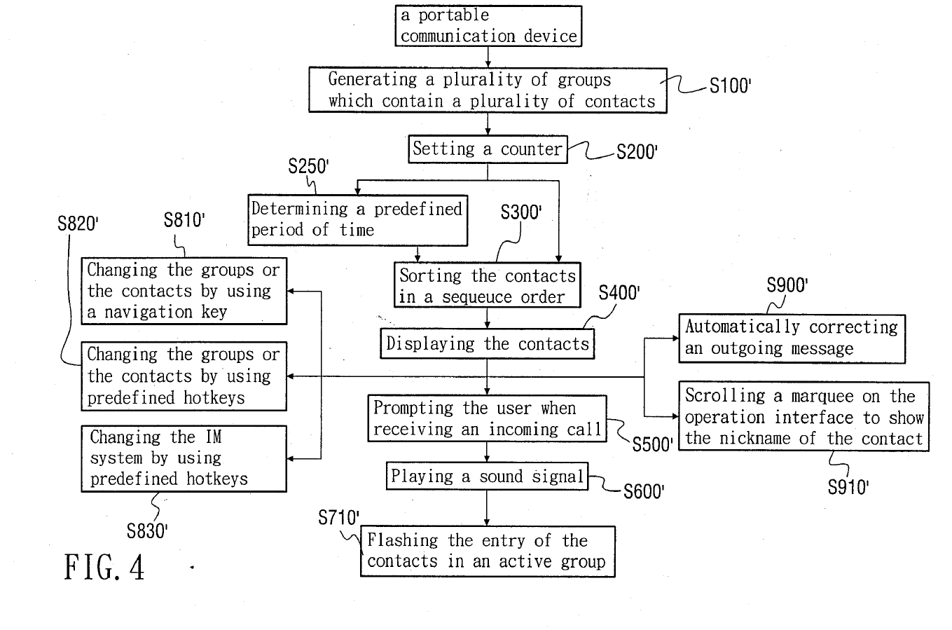

FIG. 4 shows a flowchart of other methods of implementing an operation interface for instant messages on a portable communication device according to a second embodiment of the invention.

In the second embodiment of the invention, the portable communication device used in the present invention includes a display screen, a navigation key, and several key buttons. This embodiment of the invention also includes the following steps: a user generates several groups in the portable communication device, such as an active group and a non-active group, and each group is containing several contacts on the operation interface in the display screen (S100′); a counter for the contacts is set to accumulate and count the number of times of receiving incoming messages or sending outgoing messages for each corresponding contact (S200′); sorting the contacts in a sequence order according to the counted values is performed (S300′); the contacts on the operation interface in the display screen according to the sorted contacts is displayed (S400′). Before the step of sorting the contacts in a sequence order according to the counted values is performed, the user can set a predefined period of time for sorting (S250′).

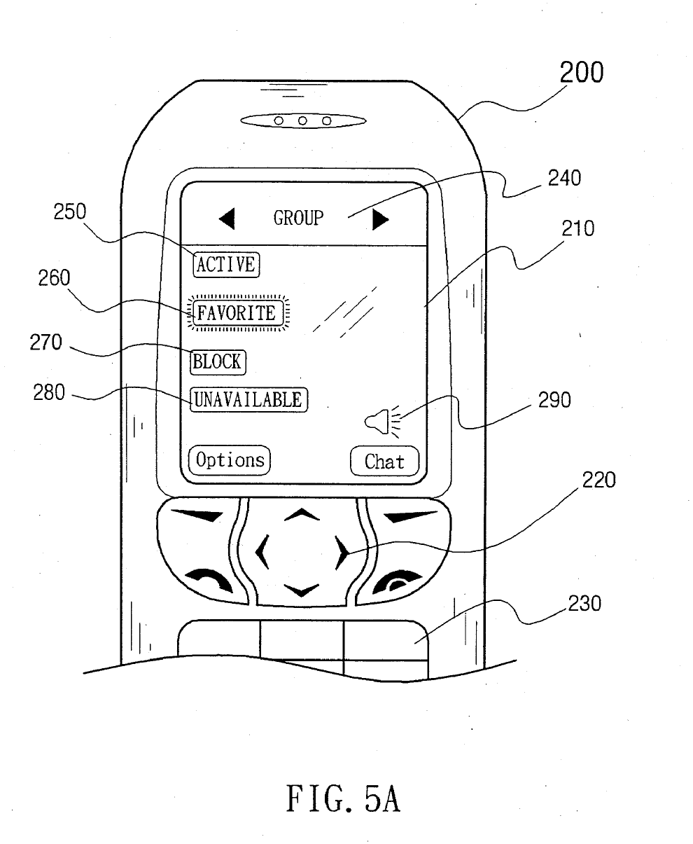

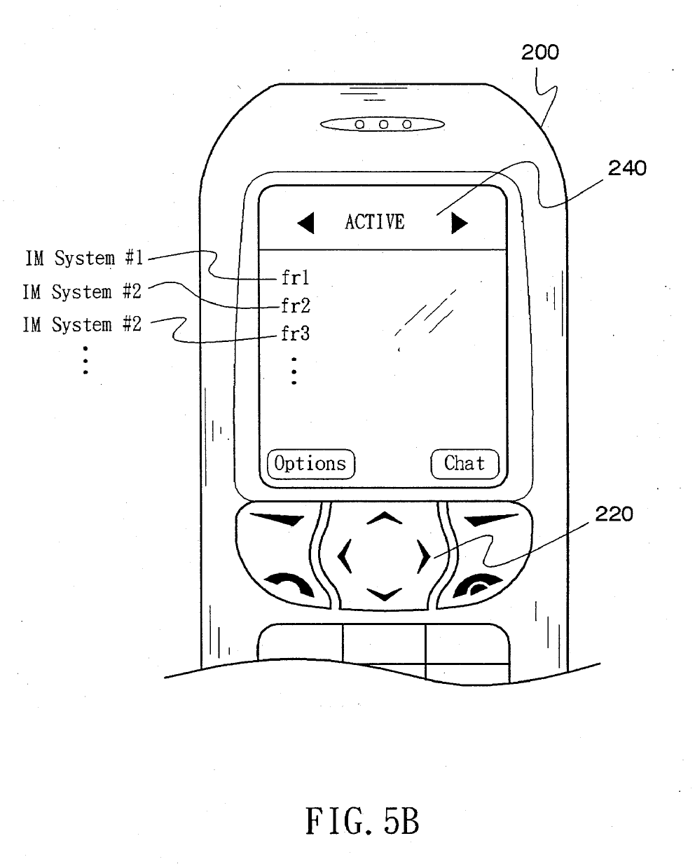

In addition, once the user receives an incoming message, the portable communication device can prompt the user for notifying (S500′). The prompting may be a sound signal (see FIG. 5A-290) played by the portable communication device (S600′). Further, the portable communication device can flash the entry of the contact (such as MSN or Yahoo entry) or its respective group if the incoming message comes from an active group (S710′) or favorite group (see FIG. 5A-260). Besides, when the user needs to find another group or contact, the user may utilize the navigation key or predefined hotkeys on the portable communication device (S810′ and S820′). The predefined hotkeys may be some of the button keys. Also, when the user wants to change the IM system, the predefined hotkeys may be utilized by the user to change between IM systems such as switching a MSN to Yahoo chat (S830′). In an alternative embodiment of the invention, the task of switching groups or IM systems may be function carried out by voice-activated commands programmed into the device as is known in the field. Voice-activation software and components in mobile devices used today for performing common tasks such as speed dialing, voicemail access and sports or weather updates can be applied to this embodiment of the invention.

Furthermore, another embodiment of the invention can also can automatically correct spelling or grammar error of an outgoing message if the portable communication device detects that an outgoing message is edited (S900′), and more convenience may be added in that the user can scroll a marquee on the operation interface to see the nickname of the contact (S910′).

FIGS. 5A and 5B show an operation interface for instant messages on a portable communication device according to another embodiment of the invention as shown in FIG. 4. The portable communication device 200 includes a display screen 210, navigation key 220, and several button keys 230. In this embodiment, the group 240 contains an active group 250, a favorite group 260, a blocked group 270, and an unavailable group 280.

The active group 250 can be defined as all the contacts in the chatting status, whereby the user can easily switch to a different chat sessions by choosing an entry in the operation interface, and wherein the active group 250 may add many IM systems into the active group 250 as subgroups, and the user may alternately switch between those IM subgroups in a single operation interface, i.e. the group “active group” collects various chatting IM subgroups. For example, if a user is chatting with one MSN chat and two Yahoo chats, there can be (3) three separate entries of chatting subgroups displayed within the interface under the active group 250 (see FIG. 5B). Each chatting subgroup may thus include users from different IM systems in accordance with this embodiment of the invention.

The favorite group 260 can be defined as all the contracts that are in the status of receiving the most incoming message or sending the most outgoing messages, wherein the favorite group 260 may also include various contacts from different IM systems as subgroups.

The blocked group 270 can be defined as all the contacts in the blocked status, whereby the user may review the blocking status and unlock specific contacts if needed lest the user forgets the blocking status of some contacts that the user may only want to block for a short period of time. The blocked group 270 may also include various contacts from different IM systems as subgroups.

The unavailable group 280 can be defined as all the contacts in the status of having no chatting record for a determined time period, wherein the user can set the collecting period to determine the “unavailable” status, and the unavailable group 280 may also include various contacts from different IM systems as subgroups.

In this type of described arrangement for the groups, the contacts therein can be categorized in a tree-structure organization of the groups, so the contacts are not all listed on the screen at the same time, and the user of the portable communication device 200 can also easy search the contact in a convenient tree-structure (hierarchical) organization.

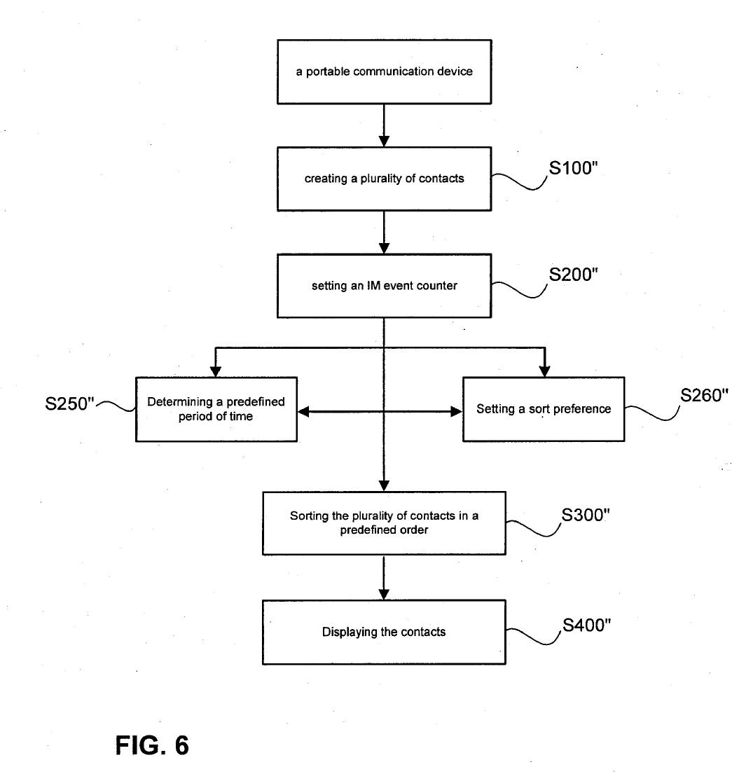

FIG. 6 shows a flowchart illustrating a method of implementing an operation interface for instant messages on a portable communication device according to one embodiment of the present invention.

In one embodiment, the portable communication device used in the invention includes a display screen. A method of implementing an operation interface for instant messages on a portable communication device may include one or more of the following steps: creating a plurality of contacts (S100″), and wherein each contact is created for display within the operation interface on the portable communication device display screen; setting an IM event counter for display corresponding to each contact (S200″); sorting the plurality of contacts according to a predefined sort preference (S300″); and displaying the plurality of contacts within the operation interface on the portable communication device display screen according to the predefined sort preference (S400″). The IM event counter can be set to record and count the number of times (1, 2, 3, 4 . . . ) that incoming messages are received and/or outgoing messages are sent by a user for each corresponding contact. Alternatively, or in addition, the IM event counter can be set to record the number of messages read and/or number of messages unread by the user for each corresponding contact. Before performing the step of sorting the contacts in a sequence order according to the counted values is preferably performed, the user can set a predefined period of time for sorting (S250″). For example, the step of sorting the contacts can be initialized each day (e.g., every 24 hours or other time interval) and respective counters can be reset to “0” value(s). A preferable embodiment of the invention allows a user to clear or reset the counters provided herein manually as desired. The user can also clear the counter(s) specific to a individual contact or group of contacts, or all contacts (select all). In another alternate embodiment of the invention, the predefined sort preference may have a default value or preference. For example, the predefined sort preference may be defaulted to sort the contacts by display names in alphabetical order.

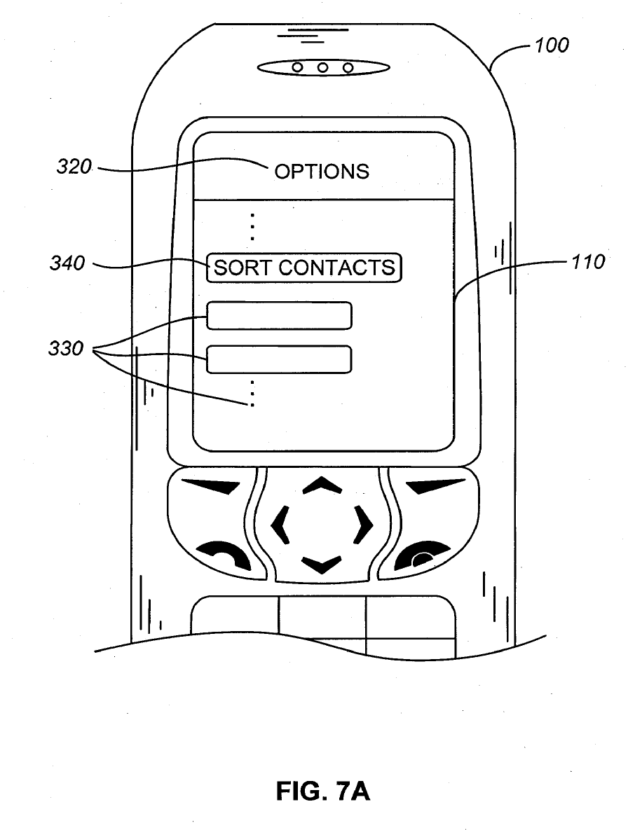

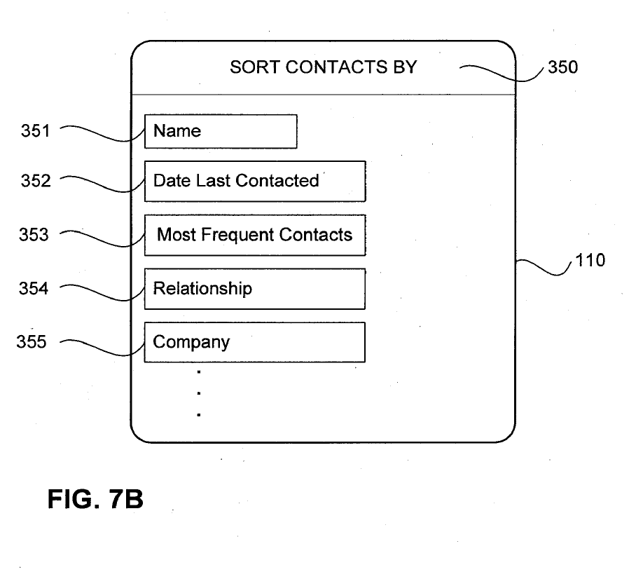

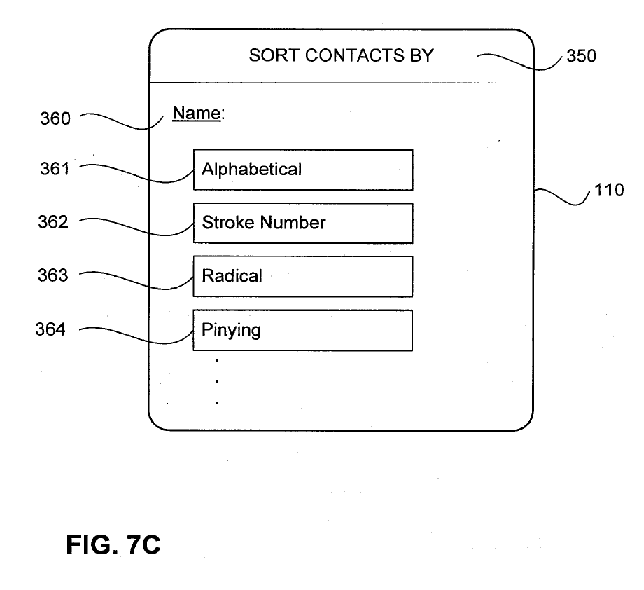

Alternatively, before performing the step of sorting the contacts in a sequence order according to the counted values is preferably performed, the user can set a predefined sort preference (S260). FIGS. 7A, 7B and 7C show a user interface for sorting a contact list for instant messages on a portable communication device implemented by a method similar to that described in FIG. 6. In FIG. 7A, the portable communication device 100 includes a display screen 110. In this embodiment of the invention, the interface on the display screen 110 includes an options menu 320, which includes several options 330. One of these options SORT CONTACTS 340 may allow the user to define a sort preference. Each of these or any other defined option provided herein may be identified with a corresponding menu choice or other graphical illustration on the display screen 110. It shall be understood that other alternative options may be used or included in the invention.

FIG. 7B illustrates an example of a menu that is displayed by the interface on the display screen 110 if the user selects an option allowing the user to define a user's sort preference 340. After choosing the sort option 340, the interface on the display screen 110 may include a sort menu 350, which includes several sort preference options {351 (Name), 352 (Date Last Contacted), 353 (Most Frequent Contacts), 354 (Relationship), 355 (Company)}. Each of these or any other defined sort preference option provided herein may be identified with a corresponding menu choice or other graphical illustration on the display screen 110. It shall be understood that other alternative sort preference options may be used or included in the invention.

FIG. 7C illustrates an example of a menu that is displayed by the interface on the display screen 110 if the user selects the option allowing the user to define the user's sort preference to be sorting the contacts by Name 351. After choosing the option to sort contacts by Name 351, the interface will display on the display screen 110 an additional sort by name menu 360, which may include even more sort by name preference options {361 (Alphabetical), 362 (Stroke Number), 363 (Radical), 364 (Pinying)}. Each of these or any other additionally defined sort preference options provided herein may be identified with a corresponding menu choice or other graphical illustration on the display screen 110. Accordingly, this embodiment of the invention provides multiple layers of sorting that can be applied to contacts in a hierarchical manner (1^{st} Name, 2^{nd} Stroke Number, 3^{rd} Most Frequent Contacts . . . ) rather than only one kind of sort. It shall be understood that other alternative sort options is not limited to sorting by name initially and may include other kinds of sorting options in accordance with this aspect of the invention.

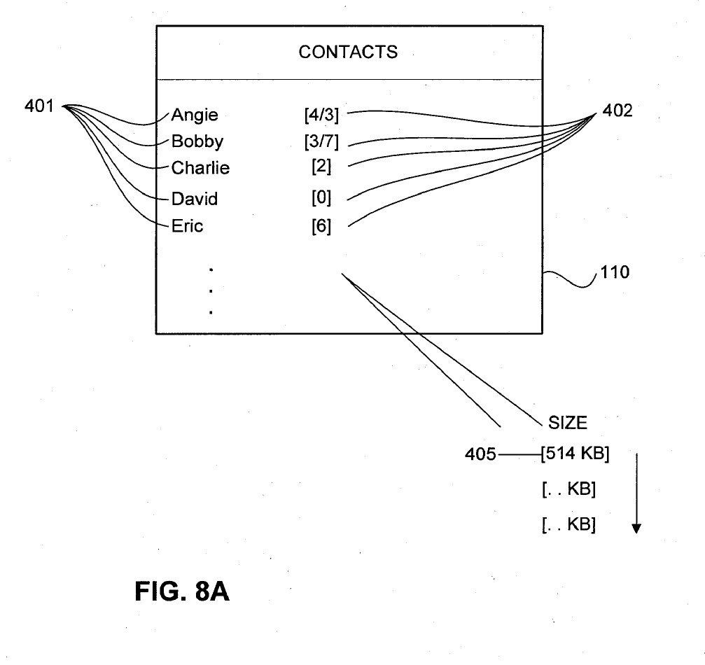

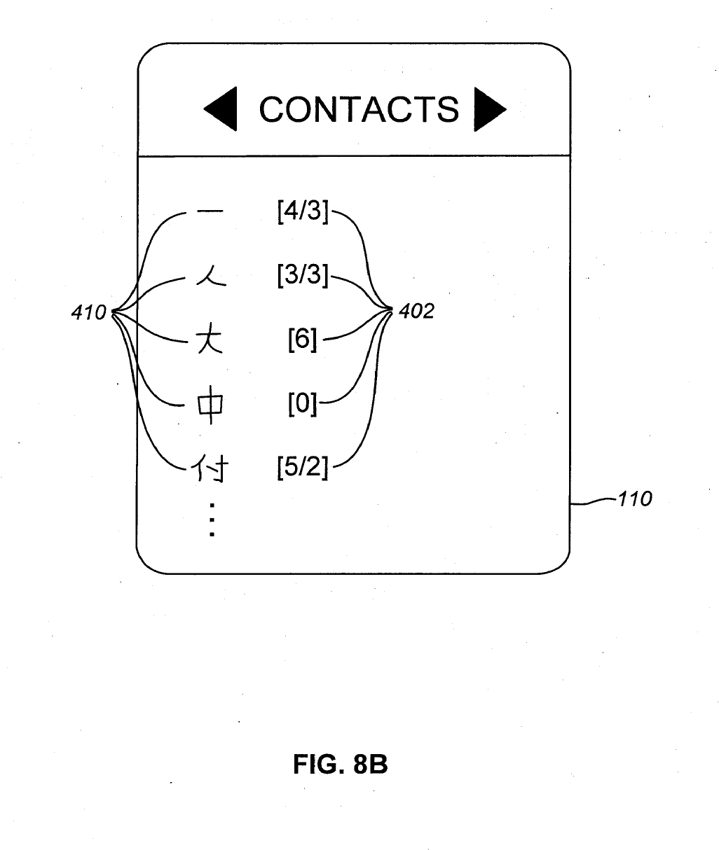

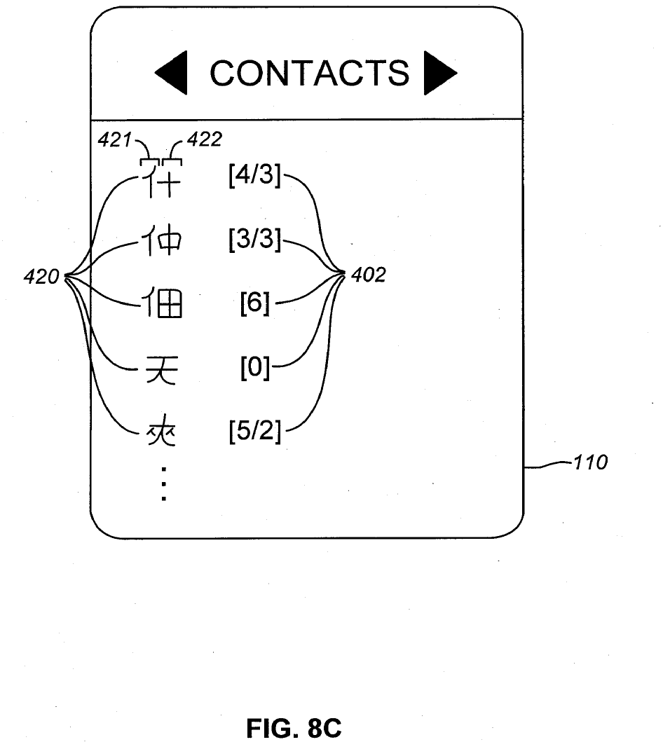

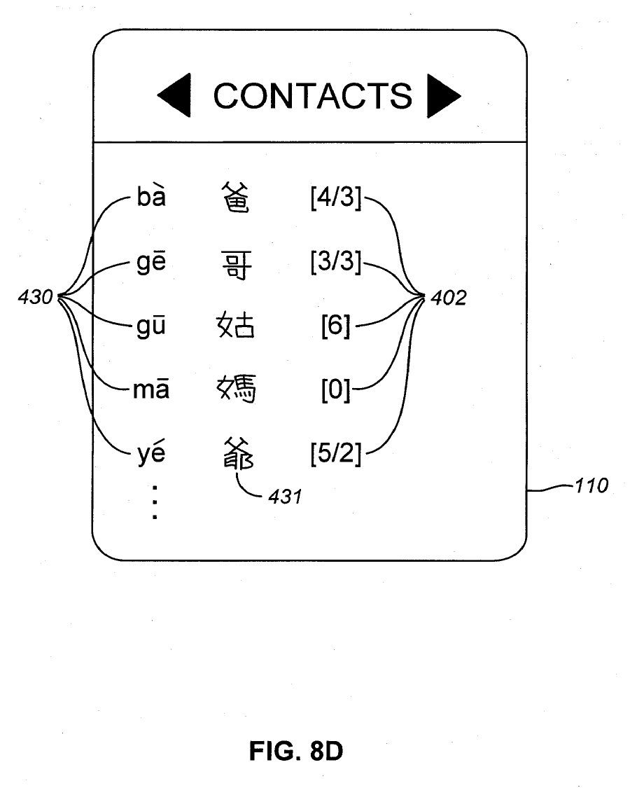

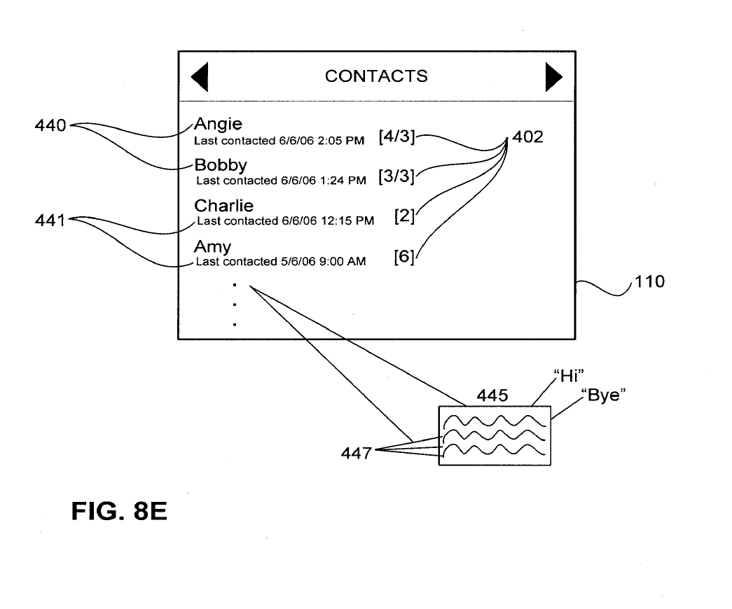

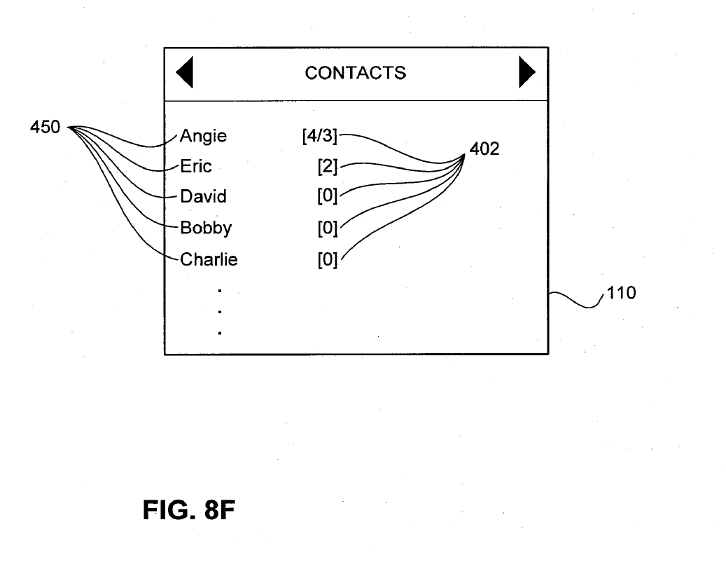

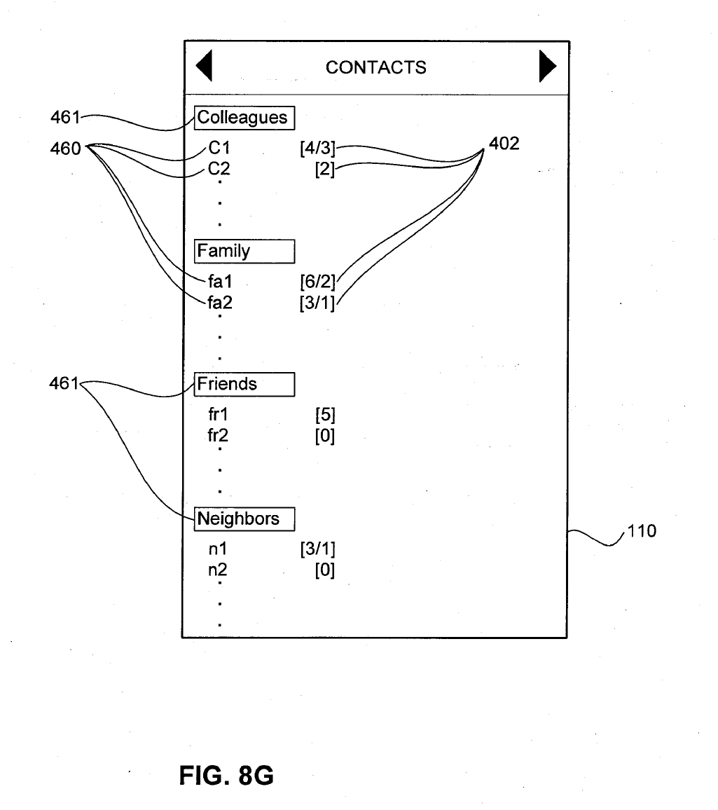

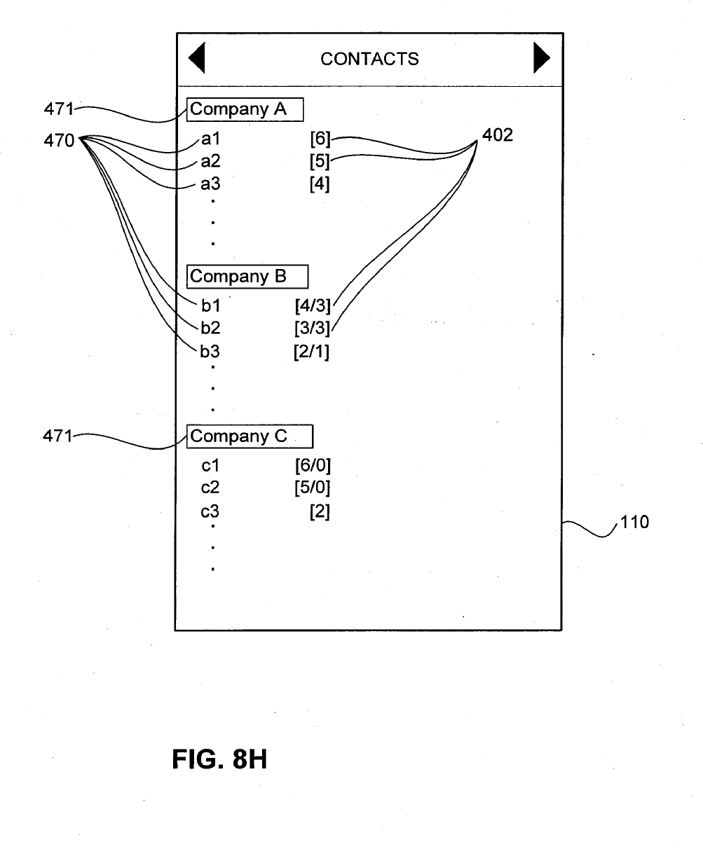

From the sort contacts by name menu 360 (FIG. 7C), the user can choose the Alphabetical option 361, to further set the sort preference to order by display names alphabetically. FIG. 8A illustrates an example of a contact list for instant messages on a portable communication device sorted alphabetically by display name. As shown here, the names 401 are all in alphabetical order on the display screen 110. FIG. 8A also illustrates values recorded by an IM event counter 402 corresponding to each contact. In one embodiment, the IM event counter 402 may record the number of times incoming messages are received (x) and/or outgoing messages are sent (y) for each contact. In alternate embodiments, the display screen may show [x/y], representing [number of incoming/number of outgoing]; or [x/x+y], representing [number of incoming/total number of messages], or simply [x] or simply [y], representing [number of incoming] or [number of outgoing], respectively; or any combination of the above; or any combination of x, y, and/or x+y. In another alternate embodiment, the IM event counter 402 may record the number of messages read by the user (x) for each contact and/or the number of unread messages (y) for each contact. In alternate embodiments, the display screen may show [x/y], representing [number of read/number of unread]; or [y/x+y], representing [number of unread/total number of messages], or simply [x] or simply [y], representing [number of read] or [number of unread], respectively; or any combination of the above; or any combination of x, y, and/or x+y. The IM event counter 402 is also illustrated in FIGS. 8B, 8C, 8D, 8E, 8F, 8G, and 8H. In another alternate embodiment, the display names are additionally expressed in Chinese characters or Hanzi.

An alternative embodiment of the invention which can be applied to other event or message counters described elsewhere herein provides the amount of memory used or occupied by a particular contact. The number and size of messages or events associated with a particular contact may vary between each other. In the event memory space becomes an issue, a user may delete messages for some contacts to create more free disk space. Moreover, an additional sorting function may be selected where contacts are initially sorted by name but can be re-sorted according to the number of bytes occupied by the contacts in either ascending or descending order. It shall be understood that any combination of message counters and/or memory indicators can be used throughout various screens and sorting options in accordance with this aspect of the invention.

From the sort contacts by name menu 360, the user can choose the Stroke Number option 362, if the display names are expressed in Chinese characters or Hanzi, to set the sort preference to order by the total number of strokes of each of the display names. FIG. 8B illustrates an example of a contact list for instant messages on a portable communication device 100, where the display names 410 are expressed in Chinese characters or Hanzi, sorted by the total number of strokes of each of the display names 410. If this option is chosen, the portable communication device 100 will order each of the display names 410 by the total number of strokes and then display the contact display names 410 on the display screen 110.

From the sort contacts by name menu 360, the user can choose the Radical option 363, if the display names are expressed in Chinese characters or Hanzi, to set the sort preference to order first by the number of strokes in the radical, and second by the number of strokes in the non-radical of each Chinese character or Hanzi. FIG. 8C illustrates an example of a contact list for instant messages on a portable communication device 100, where the display names 420 are expressed in Chinese characters or Hanzi, sorted first by the number of strokes of the radical 421 of each Chinese character or Hanzi and then by the number of strokes of the non-radical 422 of each Chinese character of Hanzi. If this option is chosen, the portable communication device 100 will order each of the display names 420 first by the number of strokes in the radical 421 and then by the number of strokes of the non-radical 422, and then display the contact display names 420 on the display screen 110.

From the sort contacts by name menu 360, the user can choose the Pinying option 364, if the display names are expressed in Pinying, to set the sort preference to order the display names in Pinying order. FIG. 8D illustrates an example of a contact list for instant messages on a portable communication device 100, where the display names 430 are expressed in Pinyin, sorted in Pinyin order. In one alternate embodiment, the display names are additionally expressed in Chinese characters or Hanzi 431. If this option is chosen, the portable communication device 100 will order each of the display names 430 in Pinyin order and then display them on the display screen 110.

From the sort preferences menu 350, the user can choose the Date Last Contacted option 352 to set the sort preference to order the contacts by the date the contact was last contacted. FIG. 8E illustrates an example of a contact list for instant messages on a portable communication device, sorted by the date each contact was last contacted. A time-last-contacted tracker 441 will need to be initiated and set for each contact upon creation of the contact. Each time a message is sent to the contact or received by the contact, the time-last-contacted tracker 441 for that contact will update with a timestamp of the date and time of the message that was sent or received by the contact. In an alternate embodiment, the user may specify over what period of time the sort preference should apply. For example, if the user specifies that the sort preference should apply to the last week only, then the time-last-contacted tracker 441 will be reset for each contact for which the time-last-contacted tracker 441 has a timestamp of over a week. When the user chooses the Date Last Contacted option 352, the display names 440 are displayed on the display screen 110, in order of the value of the time-last-contacted trackers 441 for each user. An alternative embodiment of the invention applying a similar concept may provide a preview window, a scrolling marquee or a float window 445 displaying latest or most recent chat messages 447. These could reside in or occupy a defined region within display screens described herein. More preferably, only main or selected portions of messages or chats can be displayed so that relatively unimportant footers/headers or greetings/closing (e.g., hi, bye, good-bye) are filtered out or eliminated from viewing on any selected potion of a device screen. For example, a float window can let any or all of its boundaries float with the movements of a cursor, while a scrolling marquee or preview (focus) window can be set at positions a constant distance left or right of, up or down from the cursor or the edge of a display screen.

From the sort preferences menu 350, the user can choose the Most Frequent Contacts option 353 to set the sort preference to order the contacts by the frequency of communication between the user and that contact. FIG. 8F illustrates an example of a contact list for instant messages on a portable communication device, sorted by the frequency of communications with each contact. To accomplish this sort preference, the portable communication device 100 orders the contacts according to the values of the IM event counter. In one embodiment, where the IM event counter 402 records the number of messages between the user and each contact, a sort preference to order the contacts by the frequency of communication between the user and that contact simply orders the display names by the values of the IM event counter 402. In alternate embodiments, the display screen may show IM event counter values [x/y], representing [number of incoming/number of outgoing]; or [x/x+y], representing [number of incoming/total number of messages], or simply [x] or simply [y], representing [number of incoming] or [number of outgoing], respectively; or any combination of the above; or any combination of x, y, and/or x+y. The display screen may alternatively show IM event counter values [x/y], representing [number of read/number of unread]; or [y/x+y], representing [number of unread/total number of messages], or simply [x] or simply [y], representing [number of read] or [number of unread], respectively; or any combination of the above; or any combination of x, y, and/or x+y.

From the sort preferences menu 350, the user can choose the Relationship option 354 to set the sort preference to order the contacts by the relationship type. FIG. 8G illustrates an example of a contact list for instant messages on a portable communication device, sorted by the relationship type of each contact. For example, relationship types 461 may include “Colleagues,” “Family,” “Friends,” “Neighbors,” etc. To accomplish this sort preference in a preferable embodiment, the portable communication device 100 orders the contacts first according to the relationship type 461, and second by the display name 460 in alphabetical order.

From the sort preferences menu 350, the user can choose the Company option 355 to set the sort preference to order the contacts by the company name. FIG. 8H illustrates an example of a contact list for instant messages on a portable communication device, sorted by the company of each contact. To accomplish this sort preference in a preferable embodiment, the portable communication device 100 orders the contacts first according to the company name 471, and second by the display name 470 in alphabetical order.

In these kinds of sorting arrangements described above, the contacts stored within a portable device can be user organized in a practical and effective manner according to selected preferences of each user. All contacts are therefore not displayed unnecessarily but rather in a desired order on the screen, and the user of the portable communication device 100 can also more easily search the contact through conveniently organized relationship type, company, or any other groups. As mentioned elsewhere herein, this aspect of the embodiment of the invention provides multiple layers of sorting that can be applied to contacts in a hierarchical manner (1^{st} Name, 2^{nd} Stroke Number, 3^{rd} Most Frequent Contacts . . . ) rather than only one kind of sort. The user interface of a device allows a user the opportunity to adopt or define a personal desired mixed sorting option to further group contacts within a group, and further within a group and so on. A primary sorting level can organize contacts alphabetically, which can be followed by a secondary sorting level that further organize contacts by relationship. This multiple layer sorting option may be preferable when there are a large number of items or contacts at a higher level (alphabetical) so smaller subgroups can be defined and more visible to a user. An alternative embodiment of the invention herein can include similar conceptual types of single level and multi-level sort preferences available in available software application programs such as Microsoft Excel (Data/Sort feature—Sort by Parameter 1, Then by Parameter 2, Then by Parameter 3). It shall be understood that other alternative sort options is not limited to sorting by name initially and may include other kinds of sorting options in accordance with this aspect of the invention.

The user interfaces and related methods herein for implementing an operation interface for instant messages on a portable communication device offer numerous advantages. For example, some embodiments provide a convenient structure organization for contacts, an easy operation of the navigator key, diversified indication of an incoming and/or message, and automatic correction for an outgoing message. Other embodiments provide a convenient structure organization for contacts and diversified indication of a read and/or an unread message. Other embodiments allow sorting contact display names expressed in Chinese characters or Hanzi to be sorted by stroke number order or radical order. Therefore, these and other aspects of the invention provide interfaces for instant messages on a portable communication device to enable a user to easily identify the contact of an incoming message, to rapidly search and access the desired contact, to correct any error in an outgoing message, and to define sort preferences for customized displays of such contacts. It shall be understood that other alternative sort and display options may be used or included in the invention.

The embodiments described above are only to clarify the invention to enable the persons skilled in the art to understand, make, and use the invention but not to limit the scope of the present. Any equivalent modification or variation according to the spirit of the present invention disclosed herein is to be included within the scope of the present invention.

What is claimed is:

1. A method of implementing an operation interface for instant message (IM) systems on a portable communication device display screen comprising the following steps:
creating a plurality of contacts for display within the operation interface on the portable communication device display screen;
providing an IM event counter for display corresponding to each contact;
sorting the plurality of contacts according to a predefined sort preference; and
displaying the plurality of contacts within the operation interface on the portable communication device display screen according to the predefined sort preference.

2. The method of claim 1, wherein the IM event counter records the number of times incoming messages are received or outgoing messages are sent corresponding to each contact.

3. The method of claim 1, wherein the IM event counter records the number of messages read or messages unread corresponding to each contact.

4. The method of claim 1, wherein each contact is associated with a display name.

5. The method of claim 4, wherein the predefined sort preference orders the contacts by display names in alphabetical order.

6. The method of claim 4, wherein the display names are expressed in Chinese characters or Hanzi formed of a selected number of strokes and radicals.

7. The method of claim 6, wherein the predefined sort preference further orders the contacts by the total number of strokes of each of the display names.

8. The method of claim 6, wherein the predefined sort preference further orders the contacts first by the number of strokes of the radical of each Chinese character or Hanzi and then by the number of strokes of the non-radical of each Chinese character or Hanzi.

9. The method of claim 4, wherein the display names are expressed in Pinyin, and wherein the predefined sort preference orders the contacts by display names in Pinyin order.

10. The method of claim 1, further comprising a step of setting a time-last-contacted tracker for each contact to record the date and time an incoming or outgoing message was last received or sent to that contact.

11. The method of claim 10, wherein the predefined sort preference orders the contacts by the time-last-contacted tracker.

12. The method of claim 1, wherein the predefined sort preference further orders the contacts by the instant-message event counter values.

13. The method of claim 12, wherein the predefined sort preference further orders the contacts by the instant-message event counter values in ascending order.

14. The method of claim 12, wherein the predefined sort preference further orders the contacts by the instant-message event counter values in descending order.

15. The method of claim 1, wherein each contact is associated with a relationship type, and further wherein the predefined sort preference orders the contacts by the relationship type.

16. The method of claim 1, wherein each contact is associated with a company name, and further wherein the predefined sort preference orders the contacts by the company name.

17. The method of claim 1, further comprising the step of displaying a floating window showing at least a portion of a message for a selected contact.

18. An instant message (IM) system user interface comprising:
a listing of a plurality of contacts ordered in a predefined sort preference;
a link to a plurality of sort preference options so that upon selection of a desired sort option, the plurality of contacts can be ordered according to the selected sort preference; and
a graphical representation of the values of an IM event counter corresponding to each contact.

19. The IM system user interface of claim 18, further comprising a float window showing at least a portion of a message from a selected contact.

20. A computer readable medium having program code recorded thereon for presenting an instant message (IM) system user interface, the program code causing a machine to perform the following method steps:
creating a plurality of contacts for display within the operation interface on the portable communication device display screen;
providing an IM event counter for display corresponding to each contact;
sorting the plurality of contacts according to a predefined sort preference; and
displaying the plurality of contacts within the operation interface on the portable communication device display screen according to the predefined sort preference.
